(19) United States
(12) Patent Application Publication
(10) Pub. No.: US 2014/0068159 A1
(43) Pub. Date: Mar. 6, 2014

(54) MEMORY CONTROLLER, ELECTRONIC DEVICE HAVING THE SAME AND METHOD FOR OPERATING THE SAME

(71) Applicant: SAMSUNG ELECTRONICS CO., LTD., Suwon-si (KR)

(72) Inventors: JONG-WON YI, SEOUL (KR); YU-SUNG KIM, GIMPO-SI (KR); JEONG-WOOK MOON, HWASEONG-SI (KR)

(73) Assignee: SAMSUNG ELECTRONICS CO., LTD., Suwon-si (KR)

(21) Appl. No.: 13/971,939

(22) Filed: Aug. 21, 2013

(30) Foreign Application Priority Data
Sep. 3, 2012 (KR) 10-2012-0097252

(51) Int. Cl. G06F 12/02

(52) U.S. Cl. CPC G06F 12/0246
USPC 711/103

(57) ABSTRACT

A memory controller includes first and second interfaces, a microprocessor, a register and a plane control unit. The first interface is configured to receive a first command and plane logic information of a plurality of planes in a memory device from a host. The microprocessor is coupled to the first interface, and configured to decode the first command to provide a corresponding second command, and to map the plane logic information to be suited to a non-volatile memory device. The register is configured to queue the second command and the mapped plane logic information. The second interface is configured to provide the second command and the queued plane logic information to the memory device. The plane control unit is configured to control multiple planes corresponding to portions of the queued plane logic information to perform concurrently the second command in the non-volatile memory device.

### CROSS-REFERENCE TO RELATED APPLICATION

A claim for priority under 35 U.S.C. §119 is made to Korean Patent Application No. 10-2012-0097252 filed on Sep. 3, 2012, in the Korean Intellectual Property Office, the entire contents of which are hereby incorporated by reference.

### BACKGROUND

Various embodiments of the inventive concept relate to a memory controller for controlling a non-volatile memory, an electronic device having the memory controller, and a method for operating the memory controller.

Memory devices are generally classified into volatile memory devices and non-volatile memory devices. Volatile memory devices lose data when the supply of power is interrupted. In comparison, non-volatile memory devices are able to store data even when the power supply is interrupted. Examples of non-volatile memory devices include read-only memory (ROM), electrically erasable programmable read-only memory (EEPROM), and the like.

The structure and operation of a flash memory introduced as a flash EEPROM are different from those of the conventional EEPROM. A flash memory performs electric erase operations with respect to each block, and performs program operations with respect to each bit.

### SUMMARY

Embodiments of the inventive step provide a memory controller, an electronic device including the memory controller, and a method of operating the memory controller in order to control a non-volatile memory, in which multiple planes receive information from a host and concurrently perform the respective commands, thereby increasing multi-plane operating speed.

According to an aspect of the inventive concept, there is provided a memory controller that includes first and second interfaces, a microprocessor, a register and a plane control unit. The first interface is configured to receive a first command and plane logic information of a plurality of planes in a memory device from a host. The microprocessor is coupled to the first interface, and configured to decode the first command to provide a corresponding second command, and to map the plane logic information to be suited to a non-volatile memory device. The register is configured to queue the second command and the mapped plane logic information. The second interface is configured to provide the second command and the queued plane logic information to the memory device. The plane control unit is configured to control multiple planes corresponding to portions of the queued plane logic information to perform concurrently the second command in the non-volatile memory device.

According to another aspect of the inventive concept, there is provided an electronic device including a host, and a memory controller coupled to the host and controlling one or more non-volatile memory devices. The memory controller includes a host interface communicating with the host and receiving a first command, a first address and plane logic information of a plurality of planes corresponding to the first command, a microprocessor decoding the first command to a second command, and mapping the first address and the plane logic information, and a plane control unit controlling a plurality of planes in the one or more non-volatile memory devices corresponding to the mapped plane logic information to concurrently perform the second command in the planes of the one or more non-volatile memory devices.

According to still another aspect of the inventive concept, there is provided a non-volatile memory device including a non-volatile memory cell array, a memory interfaces and control logic. The non-volatile memory cell array includes a plurality of planes, each plane having a plurality of blocks. The memory interface is configured to receive a command, a block address and plane logic information from a memory controller. The control logic is configured to control the plurality of planes corresponding to the plane logic information to concurrently perform the command.

According to still another aspect of the inventive concept, there is provided a method for operating a memory controller. The method includes receiving a first command and plane logic information of a plurality of planes in a memory from a host; decoding the first command to provide a corresponding second command, and mapping portions of the plane logic information to a non-volatile memory device and queuing the mapped portions of the plane logic information; and providing the second command and the queued portions of the plane logic information to the non-volatile memory device and controlling the second command to be performed concurrently in a plurality of planes in the non-volatile memory device corresponding to the queued portions of the plane logic information.

According to the inventive concept, plane logic information of a plurality of planes are received from a host, and a plurality of planes of a memory device mapped to portions of the plane logic information concurrently perform second commands, thereby noticeably increasing and improving operating speed of the memory device.

### BRIEF DESCRIPTION OF THE DRAWINGS

Embodiments of the inventive concept will be more clearly understood from the following detailed description taken in conjunction with the accompanying drawings in which:

FIG. 1 is a block diagram of an electronic device including a non-volatile memory system, according to an embodiment of the inventive concept;

FIG. 2 is a block diagram of a memory system, according to an embodiment of the inventive concept;

FIG. 3 is a block diagram of an electronic device including a non-volatile memory system according, to an embodiment of the inventive concept;

FIGS. 4A and 4B illustrate a sequence of transmitting commands and addresses provided from a host to a memory controller, according to embodiments of the inventive concept;

FIG. 5 illustrates a sequence of transmitting signals provided from a host to a memory controller and a non-volatile memory system, according to another embodiment of the inventive concept;

FIG. 6 is a block diagram illustrating a non-volatile memory system, according to an embodiment of the inventive concept, showing an example of the non-volatile memory device shown in FIG. 1;

FIG. 7 is a flowchart of a method for operating a memory controller, according to an embodiment of the inventive concept;

FIG. 8 is a block diagram of an electronic device including a memory controller and a non-volatile memory device, according to an embodiment of the inventive concept;

FIG. 9 is a block diagram of an electronic device including a memory controller and a non-volatile memory device, according to another embodiment of the inventive concept;

FIG. 10 is a block diagram of an electronic device including a non-volatile memory device, according to another embodiment of the inventive concept;

FIG. 11 is a block diagram of an electronic device including a memory controller and a non-volatile memory device, according to another embodiment of the inventive concept;

FIG. 12 is a block diagram of an electronic device including a memory controller and non-volatile memory devices, according to another embodiment of the inventive concept; and

FIG. 13 is a block diagram of a data processing system including the electronic device shown in FIG. 12, according to an embodiment of the inventive concept.

### DETAILED DESCRIPTION OF THE EMBODIMENTS

The inventive concept will now be described more fully with reference to the accompanying drawings, in which exemplary embodiments are shown. The inventive concept may, however, be embodied in many different forms and should not be construed as being limited to the embodiments set forth herein. Rather, these embodiments are provided so that this disclosure will be thorough and complete, and will fully convey the concept of the inventive concept to one of ordinary skill in the art. It should be understood, however, that there is no intent to limit exemplary embodiments of the inventive concept to the particular forms disclosed, but conversely, exemplary embodiments of the inventive concept are to cover all modifications, equivalents, and alternatives falling within the spirit and scope of the inventive concept. In some embodiments, well-known methods, procedures, components, and circuitry have not been described in detail to avoid unnecessarily obscuring aspects of the present invention. In the drawings, like reference numerals denote like elements and the sizes or thicknesses of elements may be exaggerated for clarity of explanation.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “comprising,” when used in this specification, specify the presence of the stated features, integers, steps, operations, elements, and/or components, but do not preclude the presence or addition of one or more other features, integers, steps, operations, elements, components, and/or groups thereof. The term “exemplary” is used to refer or otherwise relate to an example.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

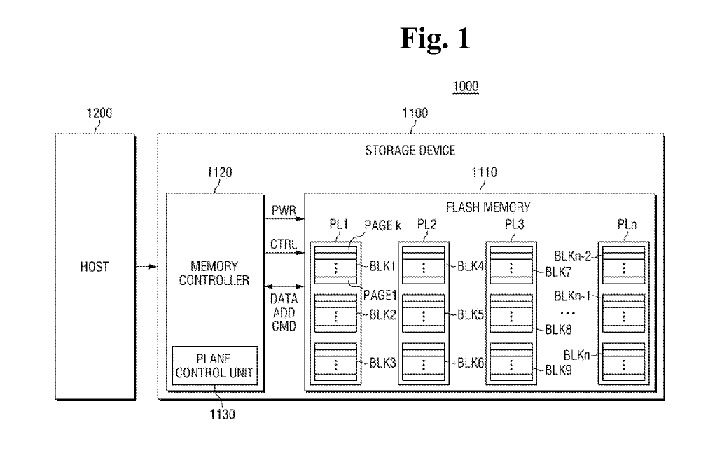

Hereinafter, an electronic device including a non-volatile memory system according to an embodiment of the inventive concept will be described with reference to FIG. 1. FIG. 1 is a block diagram of an electronic device including a non-volatile memory system, according to an embodiment of the inventive concept.

Referring to FIG. 1, an electronic device 1000 includes a host 1200 and a non-volatile memory system 1100. The host 1200 may be an electronic device such as a personal computer, a digital camera, a camcorder, a cellular phone, a smart phone, a portable device, MP3, PMP, PSP, PDA, and an e-mail transceiving device, for example. The non-volatile memory system 1100 includes a memory controller 1120 and a non-volatile memory 1110, such as a flash memory. The memory controller 1120 generally controls the non-volatile memory 1110. The non-volatile memory 1110 may perform erase, write and/or read operations under control of the memory controller 1200. To this end, the non-volatile memory 1110 receives a command (CMD), an address (ADD), and data (DATA) through an input/output (I/O) line. In addition, the non-volatile memory 1110 receives power (PWR) through a power line, and a control signal (CTRL) through a control line. The control signal CTRL may include, for example, a command latch enable (CLE) signal, an address latch enable (ALE) signal, a chip enable (nCE) signal, a write enable (nWE) signal, a read enable (nRE) signal, and the like.

By way of example, FIG. 1 shows the non-volatile memory 1110 as a flash memory, and more particularly a NAND flash memory, although embodiments of the inventive concept are not limited thereto. For example, the non-volatile memory 1110 may include one or more of a flash memory, an electrically erasable programmable read-only memory (EEPROM), a ferroelectrics random access memory (FRAM), a phase change random access memory (PRAM), a magnetoresistive random access memory (MRAM), and the like. Referring to FIG. 1, the non-volatile memory 1110 may serve as a storage unit storing data received from the host 1200. The non-volatile memory 1110 may include multiple cell arrays for storing data. The cell arrays include a plurality of planes (PL1˜PLn), where n is a natural number. Each of the planes PL1 to PLn includes a plurality of blocks BLK1 to BLKm, where m is a natural number. Each of the blocks BLK1 to BLKm include a plurality of pages PAGE1 to PAGEk, where k is a natural number. The blocks BLK1 to BLKm are units by which an erase operation is performed in response to an erase command. That is, an erase operation is performed with respect to each block of the blocks BLK1 to BLKm. The pages PAGE1 to PAGEk are units by which program and read operations are performed in response to program and read commands, respectively. That is, the program and read operations may be performed concurrently with respect to each page of the pages PAGE1 to PAGEk.

In the memory system 1000, according to an embodiment of the inventive concept, the memory controller 1120 includes a plane control unit 1130 for controlling operations of the planes PL1 to PLn of the non-volatile memory 1110. For example, the plane control unit 1130 may control read or erase commands to be performed concurrently in the planes PL1 to PLn of the non-volatile memory 1110.

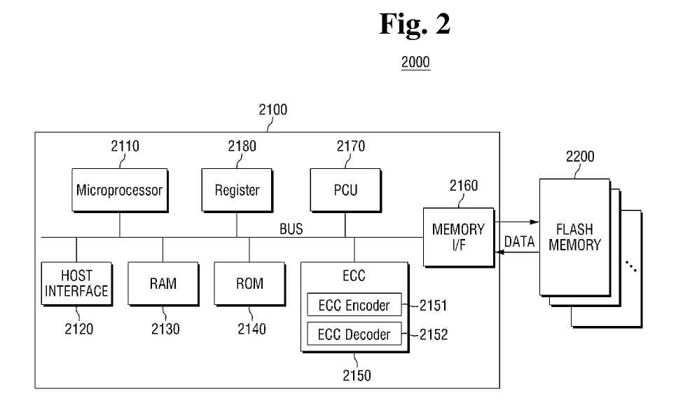

FIG. 2 is a block diagram of a memory system, according to an embodiment of the inventive concept.

Referring to FIG. 2, a memory system 2000 includes a non-volatile memory device 2200 and a memory controller 2100. The non-volatile memory device 2200 includes one or more non-volatile memories as shown in FIG. 1. For example, the non-volatile memory device 2200 may include one or more of a flash memory, an EEPROM, a FRAM, a PRAM, a MRAM, and the like, as shown in FIG. 1. In addition, referring to FIG. 2, the non-volatile memory device 2200 may serve as a storage unit for storing data received from the memory controller 2100. For purposes of illustration, the non-volatile memory device 2200 may be a NAND flash memory, for example, although embodiments of the inventive concept are not limited thereto. The non-volatile memory device 2200 includes multiple cell arrays for storing data. The cell arrays include a plurality of planes, where each of the planes includes a plurality of blocks, and each of the blocks includes a plurality of pages.

The memory controller 2100 includes a microprocessor 2110, a random access memory (RAM) 2130, a read only memory (ROM) 2140, an error correction code (ECC) unit 2150, a host interface 2120, a memory interface (I/F) 2160, a plane control unit (PCU) 2170, and a register 2180, all of which may be electrically connected to each other through a bus.

The host interface 2120 interfaces between the memory system 2000, including the memory controller 2100, and a host (not shown). Referring to FIG. 2, the host interface 2120 receives a first command and plane logic information corresponding to a plurality of planes of a logical non-volatile memory device from the host 1200. The plane logic information includes a plurality of plane logic information portions corresponding to the plurality of logic planes, respectively. In addition, the host interface 2120 may receive a block address and a page address of the non-volatile memory device 2200 corresponding to the first command from the host 1200. For example, the host interface 2120 may provide a logical address, a command latch enable (CLE) signal, an address latch enable (ALE) signal, a ready/busy (R/B) signal, and a chip enable (CE) signal from the host to the memory controller 2100. In addition, the host interface 2120 may communicate with the host according to a predetermined protocol. For example, the predetermined protocol may include Universal Serial Bus (USB), Small Computer System Interface (SCSI), PCI express, ATA, Parallel ATA (PATA), Serial ATA (SATA), and Serial Attached SCSI (SAS), although embodiments of the inventive concept are not limited thereto.

The ROM 2140 may store driving firmware codes of the memory system 2000, but embodiments of the inventive concept are not limited thereto. The firmware codes may be stored in various types of non-volatile memory devices other than the ROM 2140, including NAND flash memory, for example. Therefore, control or intervention of the microprocessor 2110 may include direct control of the microprocessor 2110 in a hardware manner and intervention of firmware that is software driven by the microprocessor 2110.

The RAM 2130 may serve as buffer memory, and may store first and second commands, first and second addresses and various variables, which are input through the host interface 2120, or data output from the non-volatile memory device 2200. In addition, the RAM 2130 may store data, various parameters and variables, input to and/or output from the non-volatile memory device 2200.

The microprocessor 2110 may be implemented using internal logic, codes, software, firmware, hardware, circuits or combinations thereof. The microprocessor 2110 generally controls operation of the memory system 2000, including a microcontroller. When power is applied to the memory system 2000, the microprocessor 2110 drives the firmware stored in the ROM 2140 to operate the memory system 2000 on the RAM 2130, thereby controlling overall operation of the memory system 2000.

In addition, the microprocessor 2110 analyzes commands provided through the host interface 2120 and may control overall operation of the non-volatile memory device 2200 according to the analyzing result. More particularly, referring to FIG. 2, the microprocessor 2110 analyzes a first command provided through the host interface 2120 and decodes the first command to provide a second command. In addition, the microprocessor 2110 maps logical addresses to physical addresses corresponding to the non-volatile memories, and maps plane logic information of a plurality of planes to be suited to the non-volatile memory device 2200. Meanwhile, the microprocessor 2110 may or may not decode the plane logic information portions of the plane logic information. That is, the microprocessor 2110 may directly provide the physical address of a plane in the non-volatile memory device 2200 to perform a read or erase operation in the host.

The memory I/F 2160 exchanges signals between the memory controller 2100 and the non-volatile memory device 2200. For example, a command requested by the microprocessor 2110 may be provided to the non-volatile memory device 2200 through the memory I/F 2160. In addition, data may be transmitted from the memory controller 2100 to the non-volatile memory device 2200. The data output from the non-volatile memory device 2200 is provided to the memory controller 2100 through the memory I/F 2160. The memory I/F 2160 provides a second command mapped under control of the microprocessor 2110 and a second address to the non-volatile memory device 2200.

The plane control unit 2170 provides the plane logic information of the plurality of logic planes to the memory I/F 2160 and controls the plurality of planes in the non-volatile memory according to the corresponding plane logic information portions in order to concurrently perform the decoded first command (i.e., the second command). The plane control unit 2170 thus controls the plurality of planes corresponding to the plane logic information to concurrently perform the second command, thereby improving performance of the non-volatile memory and increasing operating speed. According to various embodiments, the plane control unit 2170 may be positioned within the microprocessor 2110. In addition and/or alternatively, the plane control unit 2170 may be implemented using separate logic, codes, software, firmware, hardware, circuits installed in the memory controller 2100 or combinations thereof.

In addition, the microprocessor 2110 maps parameters provided from the host to be optimized to the non-volatile memory device 2200 using a first command and parameters stored in the RAM 2130. For example, when the first command provided from the host is a read command, the microprocessor 2110 maps the first command to a second command to be provided through the memory I/F 2160, e.g., a memory read command or a memory erase command. In addition, a central processing unit may map logical addresses, stored in the RAM 2130 and provided through the host, to physical addresses corresponding to the non-volatile memory device 2200.

The register 2180 may store a first command and a first address, which are input through the host interface 2120. In addition, the register 2180 may store a second command obtained by decoding the first command under the control of the microprocessor 2110. In addition, the register 2180 may store a second address obtained by decoding the first address or logical address under the control of the microprocessor 2110. The register 2180 may be positioned within the microprocessor 2110 according to embodiment. Alternatively, a separately provided register 2180 may be electrically connected to the other components, such as the microprocessor 2110, host interface 2120, the RAM 2130, the ROM 2140, the ECC unit 2150, the memory OF 2160, and/or the plane control unit 2170, of the controller 2000, e.g., via the bus. The register 2180 may be further configured to queue the second command and mapped plane logic information to be provided to the non-volatile memory device 2200.

The ECC unit 2150 performs error bit correction. Referring to FIG. 2, the ECC unit 2150 includes an ECC encoder 2151 and an ECC decoder 2152. The ECC encoder 2151 ECC encodes the data input through the host interface 2120 of the memory system 2000 and generates a codeword with a parity bit added thereto. The codeword may be stored in the non-volatile memory device 2200. The ECC decoder 2152 performs ECC decoding on read data, determines whether or not the ECC decoding is successful according to the ECC decoding performing result, and outputs an instruction signal according to the determination result. The read data is transmitted to the ECC decoder 2152, and the ECC decoder 2152 may correct error bits of the data using the parity bit. When the number of error bits generated is greater than or equal to a critical number of correctable error bits, the ECC decoder 2152 is unable to correct the error bits, resulting in an error correction fail.

The ECC encoder 2151 and the ECC decoder 2152 may perform error correction on various codes, including low density parity check (LDPC) code, BCH code, turbo code, Reed-Solomon code, convolution code, or recursive systematic code (RSC), using coded modulation, such as trellis-coded modulation (TCM) or block coded modulation (BCM), for example. However, the embodiments of the inventive concept are not limited thereto. The ECC encoder 2151 and the ECC decoder 2152 may include all of circuits, systems and/or devices for error correction.

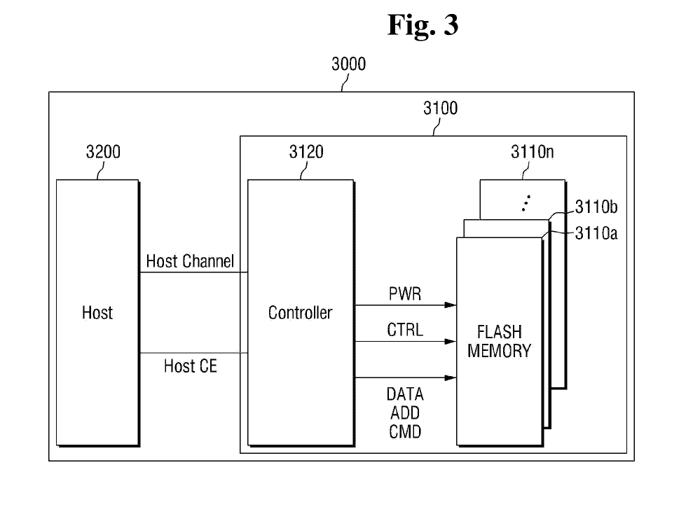

FIG. 3 is a block diagram of an electronic device including a non-volatile memory system, according to another embodiment of the inventive concept.

Referring to FIG. 3, the electronic device 3000 includes a non-volatile memory system 3100 and a host 3200. The non-volatile memory system 3100 includes a non-volatile memory device 3110 and a memory controller 3120. The non-volatile memory device 3110 includes multiple non-volatile memories, indicated by representative non-volatile memories 3110a to 3110n. The non-volatile memory system 3100 may be used for a wide variety of devices including, for example, a mobile phone, a digital camera, a portable music player, electronic toys, an email transfer device, and the like. The host 3200 includes a host processor (not shown), and the host 3200 and the non-volatile memory system 3100 communicate information, such as an initial operation command (e.g., a first command), logical addresses, input/output data, and the like, with each other through a host channel. In addition, the host 3200 may provide a chip enable (CE) signal, logical addresses, or a ready/busy (R/B) signal to the non-volatile memory system 3100.

Referring to FIG. 3, the memory system 3100 includes the memory devices 3110a to 3110n and a memory controller 3120. For convenience of explanation, the non-volatile memory device 3110 includes NAND flash memories, although embodiments of the inventive concept are not limited thereto. The memory controller 3120 receives a first command, a logical block and a logical page address (referred to as a first address) from the host 3200. In addition, referring to FIGS. 2 and 3, the memory controller 3120 receives information of a plurality of planes in the non-volatile memory device 3110 from the host 3200. According to various embodiments, the information of the plurality of planes in the non-volatile memory device 3110 corresponds to plane logic information, which may be stored in a register provided within the memory controller 3120 or within random access memory (RAM). The memory system 3100 may receive the plane logic information between the first command and the addresses (e.g., first address) corresponding to the first command. Alternatively, according to various embodiments, the memory system 3100 may receives the plane logic information after receiving the first address.

The first command may be, for example, a read command or an erase command. The memory controller 3120 provides a second command, which is obtained by decoding the first command, to the non-volatile memory device 3110 through a memory interface. The memory controller 3120 maps the first address to a physical block corresponding to the non-volatile memory device 3110 and a second address corresponding to a page address. In addition, the memory controller 3120 maps the plane logic information provided from the host 3200 to be suited to the non-volatile memory devices 3110a to 3110n. The memory controller 3120 controls the decoded first command to be concurrently performed, using plane logic information portions, on the non-volatile memory device 3110. In other words, the memory controller 3120 controls the plurality of planes corresponding to the plurality of mapped plane logic information portions to concurrently perform the second command, thereby improving performance of the non-volatile memory device 3110 and increasing the operation speed. The memory controller 3120 may control the second command to be concurrently performed on the plurality of planes in the same non-volatile memory device 3110, that is, in the same memory chip. Alternatively, the memory controller 3120 may control the plurality of planes in different non-volatile memory devices 3110.

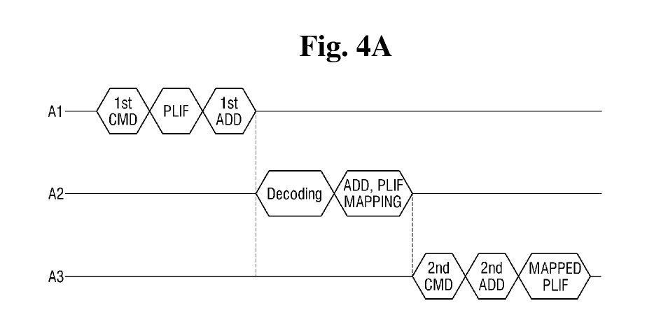

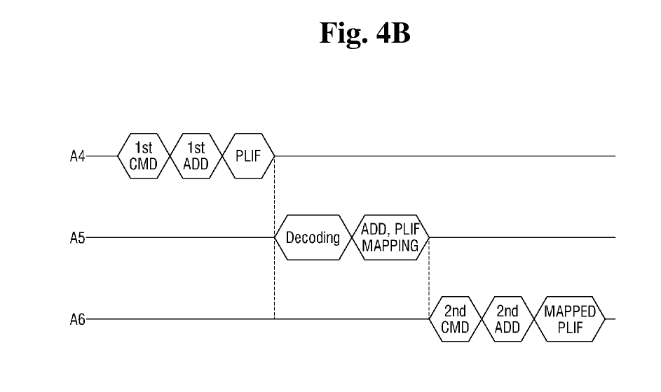

FIGS. 4A and 4B illustrate a sequence of transmitting commands and addresses provided from a host to a memory controller, according to embodiments of the inventive concept.

At stage A1 shown in FIG. 4A, the host interface provides a first command (1st CMD), plane logic information (PLIF) of a plurality of planes and a first address (1^{st} ADD) to the controller. The first command (1st CMD) may be read command or erase command, for example. The plane logic information (PLIF) is provided between the first command (1st CMD) and the first address (1^{st} ADD).

At stage A2, the microprocessor decodes the first command to provide the second command (2^{nd} CMD). The microprocessor maps the first address (1^{st} ADD) to block and page addresses of the nonvolatile memory device, and also maps the portions of the plane logic information to be suited to the memory device, where the plane logic information portions correspond to the plurality of planes in the memory device.

At stage A3, the second command (2^{nd} CMD) is provided to the nonvolatile memory device through the memory interface. The second command (2^{nd} CMD) may be a read command or an erase command, for example. The controller provides the second address (2^{nd} ADD) and the mapped plane logic information portions through the memory interface. Thus, the memory controller is able to control the planes corresponding to the plane logic information (PLIF) to perform the second command concurrently.

Referring to FIG. 4B, according to another embodiment, at stage A4, the host interface provides plane logic information (PLIF) of a plurality of planes after receiving the first command (1st CMD) and the first address (1^{st} ADD). That is, the host sequentially provides the memory controller with the first command (1st CMD), the first address (1st ADD) and the plane logic information (PLIF) in that order. Stage A5 may be the same as stage A2 shown in FIG. 4A, and stage A6 may be the same as stage A3 shown in FIG. 4A.

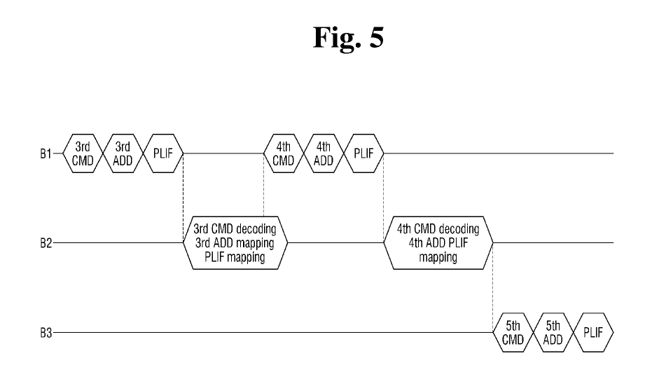

FIG. 5 illustrates a flowchart of transmitting signals provided from a host to a memory controller and a non-volatile memory system, according to another embodiment of the inventive concept.

Referring to FIG. 5, at stage B1, the host interface provides a third command (3^{rd} CMD) and a corresponding third address (3^{rd} ADD), as well as a fourth command (4^{th} CMD) and a corresponding fourth address (4^{th} ADD). In addition, the host provides the memory controller with plane logic information (PLIF) of a plurality of planes respectively corresponding to the third command (3^{rd} CMD) and the fourth command (4^{th} CMD). The third command (3^{rd} CMD) may be a cache command, for example, and the fourth command (4^{th} CMD) may be a read command or an erase command. In the depicted embodiment, the host interface provides the plane logic information (PLIF) after the third address (3^{rd} ADD). Alternatively, the host interface may provide the plane logic information (PLIF) between the third command (3^{rd} CMD) and the third address (3^{rd} ADD). Likewise, in the depicted embodiment, the host interface provides the plane logic information (PLIF) after receiving the fourth address (4^{th} ADD). Alternatively, the host interface may provide the plane logic information (PLIF) between the fourth command (4^{th} CMD) and the fourth address (4^{th} ADD).

At stage B2, the microprocessor decodes the third (3^{rd} CMD) provided at stage B1 to provide fifth commands, and maps the third address to a block of the non-volatile memory device and a page address (referred to as a fifth address). In addition, the microprocessor maps the plane logic information (PLIF) provided from the host to be suited to the non-volatile memory device.

Referring to FIG. 5, at stage B3, the fifth command provided at stage B2 is provided to the non-volatile memory device through the memory interface. For example, the fifth command may be a cache read command. The memory controller provides the fifth address (5^{th} ADD) and the plane logic information (PLIF) of the plurality of logic planes through the memory interface. Therefore, the memory controller is able to control planes corresponding to the plane logic information (PLIF) to concurrently perform the fifth command (5^{th} CMD). The third command (3^{rd} CMD) may be a cache command, and the fourth command (4^{th} CMD) may be a cache read command, for example.

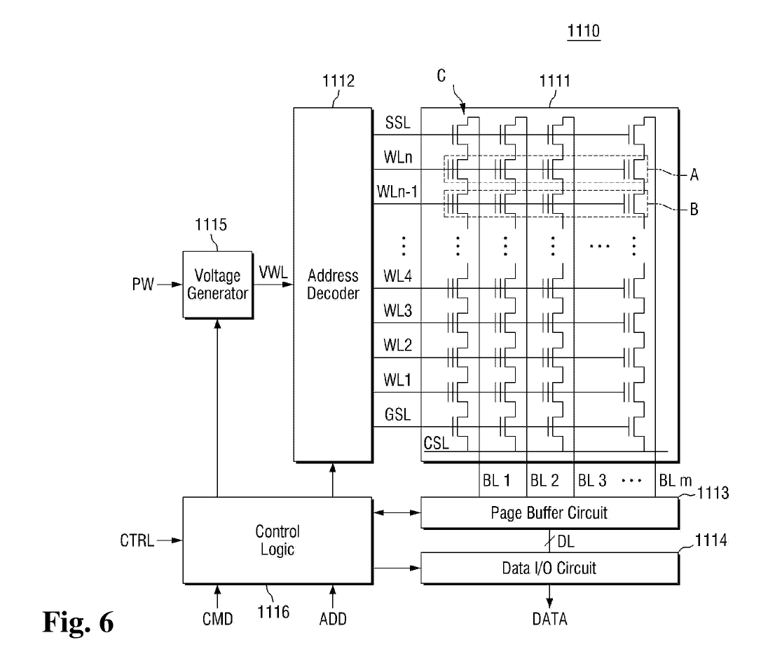

FIG. 6 is a block diagram illustrating a non-volatile memory system, according to an embodiment of the inventive concept. In particular, FIG. 6 shows a flash memory as an example of non-volatile memory device 1100 shown in FIG. 1.

Referring to FIG. 6, the non-volatile memory 1110 (e.g., flash memory) includes a memory cell array 1111, an address decoder 1112, a page buffer circuit 1113, a data input/output (I/O) circuit 1114, a voltage generator 1115, and control logic 1116.

The memory cell array 1111 includes a plurality of memory blocks. In FIG. 6, one memory block is illustrated by way of example. Each memory block may include a plurality of physical pages. For example, each physical page may correspond to a set of memory cells connected to one word line. In FIG. 6, reference symbols A and B denote representative physical pages (corresponding to word lines WLn and WLn-1, respectively). Each physical page includes a plurality of memory cells, and each memory cell includes a cell transistor consisting of a control gate and a floating gate, for example.

Single bit data or multi-bit data (two or more bits) may be stored in one memory cell. A memory cell in which single bit data can be stored is referred to as a single level cell (SLC) or a single bit cell, and a memory cell in which multi bit data can be stored is referred to as a multi level cell (MLC) or a multi bit cell. In the case of a 2-bit MLC flash memory, two logical pages can be stored in one physical page. Logical page refers to a set of data that can be concurrently programmed in one physical page. In the case of a 3-bit MLC flash memory, three logical pages may be stored in one physical page.

The memory cell array 1111 includes a plurality of cell strings. Each cell string (e.g., reference symbol C) includes a string selection transistor connected to a string selection line (SSL), memory cells connected to word lines WL1 to WLn, and a ground selection transistor connected to a ground selection line (GSL). The string selection transistor of each cell string is connected to a bit line corresponding to the cell string (e.g., one of bit lines BL1 to BLm), and the ground selection transistor is connected to a common source line (CSL). The CSL may receive a ground voltage or a CSL voltage (e.g., VDD) from the voltage generator 1115.

Referring to FIG. 6, the address decoder 1112 is connected to the memory cell array 1111 through the selection line (SSL, GSL) and/or the word lines WL1 to WLn. During a program or read operation, the address decoder 1112 may receive an address (ADD) and may select one of the word lines (e.g., WL1) in response.

The page buffer circuit 1113 is connected to the memory cell array 1111 through the bit lines BL1 to BLm. The page buffer circuit 1113 includes multiple page buffers (not shown). One bit line may be connected to one page buffer (all BL structure), or two or more bit lines may be connected to one page buffer (shield BL structure). The page buffer circuit 1113 may temporarily store data to be programmed in a selected page A of the memory cell array 1111, for example, or read data from the selected page.

The data input/output circuit 1114 is internally connected to the page buffer circuit 1113 through a data line (DL) and is externally connected to a memory controller (e.g., memory controller 1120 of FIG. 1) through an input/output line (I/O). The data input/output circuit 1114 receives program data from the memory controller 1120 during a program operation and provides read data to the memory controller 1120 during a read operation.

The voltage generator 1115 receives power (PW) from the memory controller 1120 and generates a word line voltage (VWL) required to read or write data. The word line voltage VWL is provided to the address decoder 1112.

The control logic 1116 controls operation of the non-volatile memory 1110, including a program operation, a read operation or an erase operation, using a command (CMD), an address (ADD), and a control signal (CTRL). For example, during a program operation, the control logic 1116 controls the address decoder 1112 to allow a program voltage to be provided to a selected word line (e.g., WL1) and controls the page buffer circuit 1113 and the data input/output circuit 1114 to allow program data to be provided to the selected page A. Meanwhile, the control logic 1116 further includes a plane control unit (not shown). Therefore, the control logic 1116 controls the planes corresponding to plane logic information portions to perform the command concurrently, thereby allowing the planes to concurrently perform a particular command under the control of the control logic 1116.

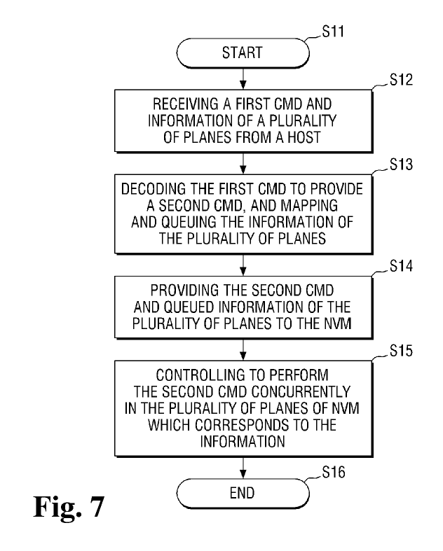

FIG. 7 is a flowchart of a method for operating a memory controller, according to an embodiment of the inventive concept.

Referring to FIG. 7, the memory controller receives a first command and plane logic information of a plurality of planes a plurality of planes in a memory device from a host (S12). The memory controller decodes the first command to provide a second command corresponding to a non-volatile memory device (S13). The first command may be a read, program, or erase command, for example. In addition, the memory controller maps the plane logic information of the plurality of logic planes to be suited to the non-volatile memory device and queues the same (S 13). The memory controller provides the second command and the queued plane logic information to the non-volatile memory device (S 14). Therefore, the memory controller is able to control the second command to be performed concurrently on the plurality of planes corresponding to the plane logic information (S15).

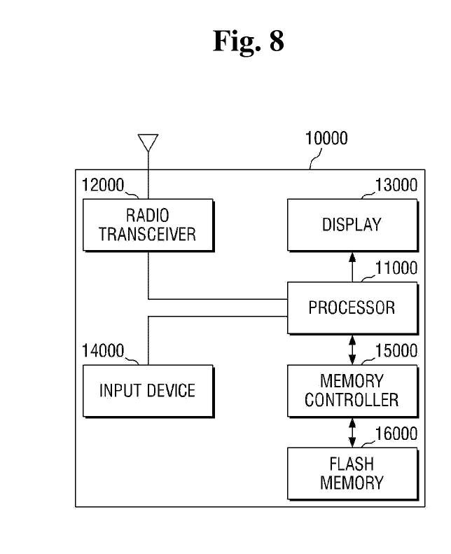

FIG. 8 is a block diagram of an electronic device including a memory controller and a non-volatile memory device, according to an embodiment of the inventive concept.

Referring to FIG. 8, an electronic device 10000, such as a cellular phone, a smart phone, or a tablet PC, includes a non-volatile memory device 16000, which can be implemented as a flash memory, and a memory controller 15000, which can control operation of the non-volatile memory device 16000. The non-volatile memory device 16000 and the memory controller 15000 are controlled by a processor 11000 controlling the overall operation of the electronic device 10000.

The data stored in the non-volatile memory device 16000 may be displayed on a display 13000 by (under the control of) the memory controller 15000 controlled by the processor 11000. In addition, the memory controller 15000 receives a first command and plane logic information of a plurality of planes from the processor 11000, and decodes the first command to provide a corresponding second command. In addition, the memory controller 15000 maps the plane logic information to be suited to the non-volatile memory device 16000 and queues the same. The memory controller 15000 provides the second command and the queued plane logic information to the memory device 16000, and controls the second command to be performed concurrently on a plurality of planes in the memory device 16000 corresponding to portions of the plane logic information.

A radio transceiver 12000 transmits and/or receives radio signals through an antenna (ANT). For example, the radio transceiver 12000 may convert the radio signal received through the antenna ANT into a signal that can be processed by the processor 11000. Therefore, the processor 11000 may process the signal output from the radio transceiver 12000 and may store the processed signal in the non-volatile memory device 16000 through the memory controller 15000 or may display the processed signal through the display 13000. The radio transceiver 12000 may also convert the signal output from the processor 11000 into a radio signal and may output the converted radio signal through the antenna ANT.

An input device 14000 is able to input a control signal for controlling the operation of the processor 11000 or data to be processed by the processor 11000. The input device 14000 may be implemented by a pointing device, such as a touch pad or a computer mouse, a keypad, or a keyboard, for example.

The processor 11000 controls the display 13000 to display the data output from the non-volatile memory device 16000, the radio signal output from the radio transceiver 12000, and/or the data provided from the input device 14000 to be displayed on the display 13000.

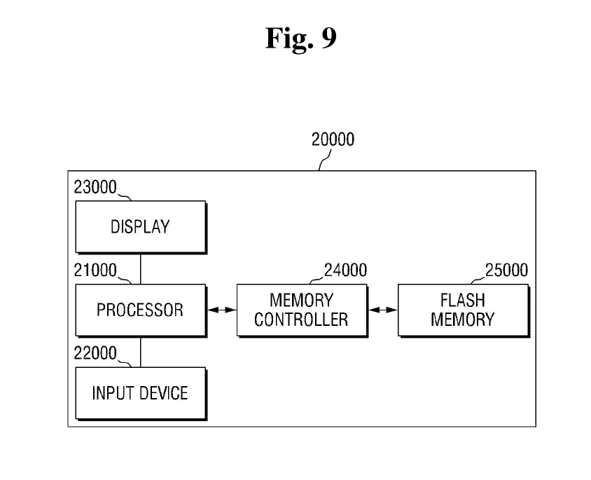

FIG. 9 is a block diagram of an electronic device including a memory controller and a non-volatile memory device, according to another embodiment of the inventive concept.

Referring to FIG. 9, an electronic device 20000 includes a non-volatile memory device 25000, such as a flash memory, and a memory controller 24000 for controlling the operation of the non-volatile memory device 25000, which can be implemented as a data processing device, such as a personal computer (PC), a tablet computer, a net-book, an e-reader, a personal digital assistant (PDA), a portable multimedia player (PMP), an MP3 player, or an MP4 player, for example. The non-volatile memory device 25000 may be the same as the non-volatile memory devices discussed with reference to FIGS. 1 to 7, for example. The non-volatile memory device 25000 may store random data.

In addition, the memory controller 24000 may be the same as the memory controller 1120 or the memory controller 2100, shown in FIGS. 1 and 2, for example. The memory controller 24000 receives a first command and plane logic information of a memory device from a processor 21000, and decodes the first command to provide a corresponding second command. In addition, the memory controller 24000 maps the plane logic information to be suited to the non-volatile memory device 25000 and queues the same. The memory controller 24000 provides the second command and queued plane logic information to the memory device 25000 and controls the second command to be performed concurrently on a plurality of planes in the memory device 25000 corresponding to portions of the plane logic information.

The electronic device 20000 further includes a processor 21000 for controlling overall operation of the electronic device 20000. The memory controller 24000 is controlled by the processor 21000. The processor 21000 may display the data stored in the non-volatile memory device 25000 on the display 23000 according to the input signal generated by an input device 22000. The input device 22000 may be implemented, for example, using a pointing device, such as a touch pad or a computer mouse, a keypad, and/or a keyboard.

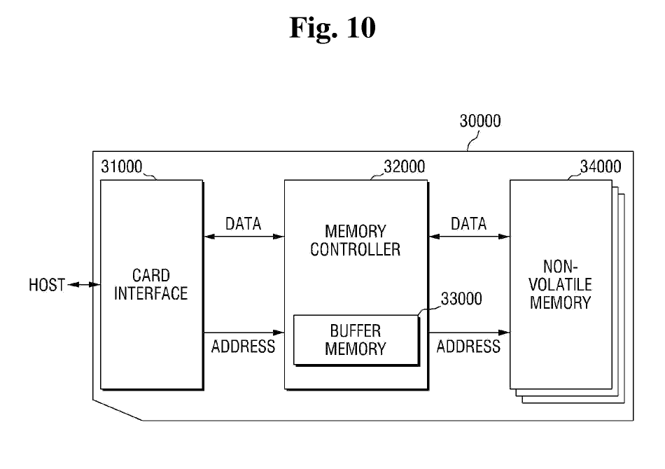

FIG. 10 is a block diagram of an electronic device including a non-volatile memory device, according to another embodiment of the inventive concept.

Referring to FIG. 10, an electronic device 30000 includes a card interface 31000, a memory controller 32000, and a non-volatile memory device 34000, e.g., a flash memory. The electronic device 30000 transmits and/or receives data to/from the host (HOST) through the card interface 31000. According to various embodiments, the card interface 31000 may be a secure digital (SD) card interface or a multi-media card (MMC) interface, for example, but embodiments of the inventive concept are not limited thereto. The card interface 31000 may interface data exchanged between the host and the memory controller 32000 according to the communication protocol of the host capable of communicating with the electronic device 30000.

The memory controller 32000 may be the same the memory controller 1120 or the memory controller 2100, shown in FIGS. 1 and 2, for example. The memory controller 32000 receives a first command and plane logic information of a plurality of planes in a memory device from the host, and decodes the first command to provide a corresponding second command. In addition, the memory controller 32000 maps the plane logic information to be suited to the non-volatile memory device 34000, and queues the same. The memory controller 32000 provides the second command and the queued plane logic information to the memory device 34000, and controls the second command to be performed concurrently on a plurality of planes in the memory device 34000 corresponding to portions of the plane logic information.

In addition, the memory controller 32000 may control data exchanged between the card interface 31000 and the non-volatile memory device 34000. A buffer memory 33000 of the memory controller 32000 may buffer data exchanged between the card interface 31000 and the non-volatile memory device 34000.

The memory controller 32000 is connected to the card interface 31000 and the non-volatile memory device 34000 through a data bus (DATA) and an address bus (ADDRESS). According to various embodiments, the memory controller 32000 may receive an address of data to be read from or written to the card interface 31000 through the address bus (ADDRESS) and transmits the received address to the non-volatile memory device 34000. In addition, the memory controller 32000 receives and/or transmits data to be read or written through the data bus (DATA) connected to the card interface 31000 or the non-volatile memory device 34000.

The non-volatile memory device 34000 may be the same as the non-volatile memory devices discussed with reference to FIGS. 1 to 7, for example. When the electronic device 30000 shown in FIG. 10 is connected to a host (HOST), such as a PC, a tablet PC, a digital camera, a digital audio player, a cellular phone, a console video game hardware, or a digital set-top box, for example, the host (HOST) may exchange data stored in the non-volatile memory device 34000 through the card interface 31000 and the memory controller 32000.

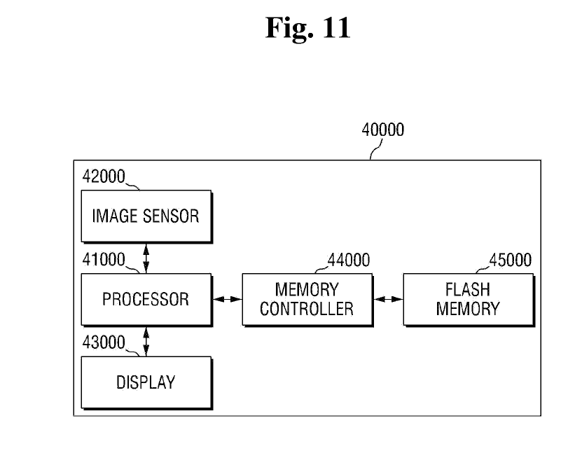

FIG. 11 is a block diagram of an electronic device including a memory controller and a non-volatile memory device, according to another embodiment of the inventive concept.

Referring to FIG. 11, an electronic device 40000 includes a non-volatile memory device 45000, such as a flash memory, a memory controller 44000 for controlling the data processing operation of the non-volatile memory device 45000, and an image sensor 41000 for controlling overall operation of the electronic device 40000. The non-volatile memory device 45000 may be the same as the non-volatile memory devices discussed with reference to FIGS. 1 to 7, for example.

The memory controller 44000 may be the same as the memory controller 1120 or the memory controller 2100, shown in FIGS. 1 and 2, for example. The memory controller 44000 receives a first command and plane logic information of a plurality of planes in a memory device from a processor 41000, and decodes the first command to provide a corresponding second command. In addition, the plane logic information is mapped to be suited to the non-volatile memory device 45000 and queued. The memory controller 44000 provides the second command and the queued plane logic information to the memory device 45000, and controls the second command to be performed concurrently on a plurality of planes in the memory device 45000 corresponding to portions of the plane logic information.

An image sensor 42000 of the electronic device 40000 converts an optical signal into a digital signal. The converted digital signal is stored in the non-volatile memory device 45000 under the control of the image sensor 42000 and/or displayed on a display 43000.

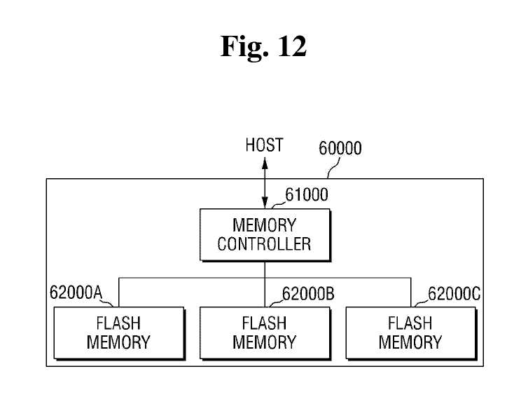

FIG. 12 is a block diagram of an electronic device including a memory controller and non-volatile memory devices, according to another embodiment of the inventive concept.

Referring to FIG. 12, an electronic device 60000 may be implemented as a data storage device, such as a solid state drive (SSD). The electronic device 60000 includes multiple non-volatile memory devices 62000A, 62000B and 62000C and a memory controller 61000 for controlling data processing operations of the non-volatile memory devices 62000A, 62000B and 62000C. The electronic device 60000 may be implemented as a memory system or a memory module, for example. Each of the non-volatile memory devices 62000A, 62000B and 62000C may be the same as the non-volatile memory devices discussed with reference to FIGS. 1 to 7, for example.

The memory controller 61000 may be the same as the memory controller 1120 or the memory controller 2100, shown in FIGS. 1 and 2, for example. The memory controller 61000 receives a first command and plane logic information of a plurality of planes in a memory device from a host, and decodes the first command to provide a corresponding second command. In addition, the memory controller 61000 maps the plane logic information to be suited to the non-volatile memory devices 62000A, 62000B and 62000C and queues the same. The memory controller 61000 provides the second command and the queued plane logic information to the memory devices 62000A, 62000B and 62000C, and controls the second command to be performed concurrently on a plurality of planes in the memory devices 62000A, 62000B and 62000C corresponding to portions of the plane logic information. According to various embodiments, the memory controller 61000 may be implemented inside or outside the electronic device 60000.

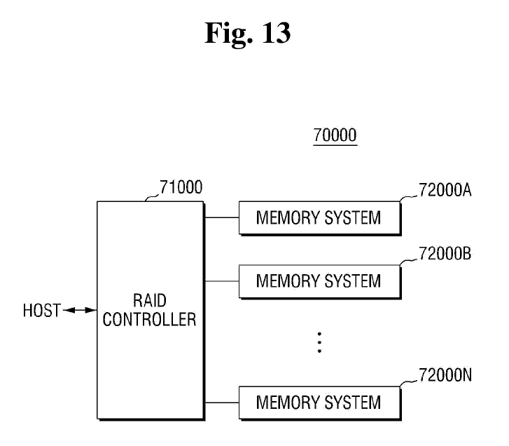

FIG. 13 is a block diagram of a data processing system including the electronic device shown in FIG. 12, according to another embodiment of the inventive concept.

Referring to FIGS. 12 and 13, a data processing system 70000, implemented as a redundant array of independent disks (RAID) system, includes a RAID controller 71000 and a multiple memory systems 72000A, 72000B, . . . and 72000N, where N is a natural number. Each of the memory systems 72000A, 72000B, . . . and 72000N may be the same as the electronic device 60000 shown in FIG. 12, for example. The memory systems 72000A, 72000B, . . . and 72000N may form an RAID array. The data processing system 70000 may be implemented as a personal computer (PC) or a solid state disk (SSD), for example.

During a program operation, the RAID controller 71000 may output program data output from a host (HOST) to one of the memory systems 72000A, 72000B, . . . and 72000N according to one of multiple RAID levels based on RAID level information output from the host.

A memory controller of each in the memory systems 72000A, 72000B, . . . and 72000N may be the same as the memory controller 1120 or the memory controller 2100, shown in FIGS. 1 and 2, for example. The memory controller receives a first command and plane logic information of a plurality of planes in a memory device from the host, and decodes the first command to provide a corresponding second command. In addition, the plane logic information is mapped to be suited to the non-volatile memory device and queued. The memory controller provides the second command and the queued plane logic information to the memory device, and controls the second command to be performed concurrently on a plurality of planes in the memory systems 72000A, 72000B, . . . and 72000N corresponding to portions of the plane logic information.

While the inventive concept has been described with reference to illustrative embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A memory controller comprising:
a first interface configured to receive a first command and plane logic information of a plurality of planes in a memory device from a host;
a microprocessor coupled to the first interface, and configured to decode the first command to provide a corresponding second command, and to map the plane logic information to be suited to a non-volatile memory device;
a register configured to queue the second command and the mapped plane logic information;
a second interface configured to provide the second command and the queued plane logic information to the memory device; and
a plane control unit configured to control a plurality of planes corresponding to portions of the queued plane logic information to perform concurrently the second command in the non-volatile memory device.

2. The memory controller of claim 1, wherein the first interface comprises a host interface configured to receive a logical address and a chip enable signal of the memory device from the host.

3. The memory controller of claim 1, wherein the second interface comprises a memory interface configured to exchange signals between the non-volatile memory device and the memory controller.

4. The memory controller of claim 1, wherein the first command is a read command.

5. The memory controller of claim 1, wherein the first command is a program command.

6. The memory controller of claim 1, wherein the first interface receives a logical address corresponding to the first command from the host, and the microprocessor maps the logical address to a physical address of the non-volatile memory device.

7. The memory controller of claim 1, wherein the first command is an erase command.

8. The memory controller of claim 2, wherein the first interface receives the plane logic information from the host between the first command and the logical address.

9. The memory controller of claim 2, wherein the first interface receives the plane logic information from the host after the receiving of the first command and the logical address.

10. The memory controller of claim 1, further comprising:
an error correction code (ECC) unit configured to perform error bit correction of data read from the memory device.

11. The memory controller of claim 1, wherein the first command is a cache read command of the non-volatile memory device.

12. The memory controller of claim 1, wherein the portions of the queued plane logic information correspond to a plurality of planes included in the non-volatile memory device.

13. An electronic device comprising:
a host; and
the memory controller of claim 1 coupled to the host, wherein the first interface comprises a host interface configured to receive the first command and the plane logic information from the host.

14. The electronic device of claim 13, wherein the host sequentially provides the first command, the plane logic information and a first address to the memory controller in that order.

15. The electronic device of claim 13, wherein the host sequentially provides the first command, a first address and the plane logic information to the memory controller in that order.

16. The electronic device of claim 13, wherein the portions of the queued plane logic information correspond to planes included in the same memory device.

17. A non-volatile memory device comprising:
a non-volatile memory cell array including a plurality of planes, each plane having a plurality of blocks;
a memory interface configured to receive a command, a block address and plane logic information from a memory controller; and
control logic controlling the plurality of planes corresponding to the plane logic information to concurrently perform the command.

18. The non-volatile memory device of claim 17, wherein the command is a read command or an erase command.

19. The non-volatile memory device of claim 17, wherein the command is a program command.

20. A method for operating a memory controller comprising:
receiving a first command and plane logic information of a plurality of planes in a memory from a host;
decoding the first command to provide a corresponding second command, and mapping portions of the plane logic information to a non-volatile memory device and queuing the mapped portions of the plane logic information; and
providing the second command and the queued portions of the plane logic information to the non-volatile memory device and controlling the second command to be performed concurrently in a plurality of planes in the non-volatile memory device corresponding to the queued portions of the plane logic information.
